(19) United States
(12) Patent Application Publication
(10) Pub. No.: US 2026/0144240 A1
(43) Pub. Date: May 28, 2026

(54) APPARATUS FOR COUPLING FISHING LINE TO FISHING HOOK

(71) Applicant: Holder Tackle LLC, Webster Grooves, MO (US)

(72) Inventor: Douglas Holder, Webster Grooves, MO (US)

(21) Appl. No.: 19/396,692

(22) Filed: Nov. 21, 2025

Related U.S. Application Data
(60) Provisional application No. 63/723,788, filed on Nov. 22, 2024.

(51) Int. Cl. A01K 91/04

(52) U.S. Cl. CPC A01K 91/04

(57) ABSTRACT

An apparatus for coupling a fishing line to a fishing hook is provided. The apparatus can include a plug and a sleeve. The plug can include a base and a projection extending from the base. The projection can have a smaller cross-sectional dimension than the base. An aperture can be formed in the plug and can receive a portion of the fishing hook. The sleeve can selectively couple to the projection of the plug, with the plug and sleeve defining an interface to receive a portion of the fishing line therebetween. When coupled, the sleeve and plug can couple the fishing line to the fishing hook. The apparatus can allow for reliable coupling of the fishing line, can reduce the dexterity and strength required, and can accommodate a variety of fishing hook sizes and line types. The apparatus can provide a method for preparing fishing tackle under varying environmental conditions.

### CROSS-REFERENCE TO RELATED APPLICATIONS

This application claims the benefit of U.S. Provisional Application No. 63/723,788, filed on November 22, 2024. The entire disclosure of the above application is incorporated herein by reference.

### FIELD

The present technology relates to fishing tackle, and, more particularly, to an apparatus for coupling a fishing line to a fishing hook.

### INTRODUCTION

This section provides background information related to the present disclosure which is not necessarily prior art.

Fishing is a worldwide recreational and sustenance activity, embraced by individuals of all ages and skill levels, making fishing a versatile and inclusive pastime for beginners, hobbyists, and experts alike. Approximately 44 million people in the United States identify as recreational anglers. While fishing attracts many participants, preparing fishing tackle, particularly attaching a fishing line to a fishing hook, poses certain challenges, especially for younger, older, or less experienced individuals. Attaching a fishing line to a fishing hook can require precise hand movements, care, and strength in completing certain knots, for example. Many individuals struggle to perform these tasks, particularly in varying weather conditions or low-light environments. Waves or water movement can also cause instability, further complicating the process.

Certain methods and equipment for attaching a fishing line to a fishing hook require users to manually thread the fishing line through an eye of the fishing hook and tie one or more specialized knots to secure the fishing line thereto. These knots must form properly and tighten sufficiently to militate against slippage or failure during casting or retrieval. Improperly tied knots can weaken the fishing line, cause the fishing hook to detach, and result in lost catches and wasted equipment. Knot-tying can also consume significant time and pose challenges to an angler under real-world fishing conditions. Wet or cold environments reduce dexterity, while limited visibility or boat movement complicates manipulation of small components such as the fishing hook and a fishing line end. Even experienced anglers can experience frustration and reduced efficiency when preparing fishing tackle in such conditions.

Various devices have attempted to assist users in attaching a fishing line to a fishing hook, but many remain cumbersome, unintuitive, or incompatible with different fishing hook sizes or fishing line materials. Some devices require multiple steps or specialized tools, while others fail to provide a secure or repeatable connection. Accordingly, there is a need for an apparatus for coupling a fishing line to a fishing hook that can reliably and securely hold the line, reduce the manual dexterity and strength required to attach the line, accommodate a variety of fishing hook sizes and fishing line types, and simplify the process of preparing fishing tackle under varying environmental conditions.

### SUMMARY

In concordance with the instant disclosure, an apparatus for coupling a fishing line to a fishing hook that can reliably and securely hold the line, reduce the manual dexterity and strength required to attach the line, accommodate a variety of hook sizes and line types, and simplify the process of preparing fishing tackle under varying environmental conditions, has surprisingly been discovered. The present technology includes articles of manufacture, systems, and processes that relate to an apparatus for coupling a fishing line to a fishing hook.

In certain embodiments, an apparatus for coupling a fishing line to a fishing hook is provided. The apparatus can include a plug and a sleeve. The plug can include a base and a projection extending from the base. The projection can have a smaller cross-sectional dimension than the base. An aperture can be formed in the plug and can receive a portion of the fishing hook. The sleeve can selectively couple to the projection of the plug, with the plug and sleeve defining an interface configured to receive a portion of the fishing line therebetween. When coupled, the sleeve and plug can couple the fishing line to the fishing hook. The apparatus can allow reliable and repeatable attachment of the fishing line, can reduce the manual dexterity and strength required, and can accommodate a variety of fishing hook sizes and line types.

In certain embodiments, a fishing implement is provided. The fishing implement can include a fishing hook and an apparatus as described herein disposed on the fishing hook. The apparatus can be configured to couple a fishing line to the fishing hook, and the plug of the apparatus can be disposed over a portion of the fishing hook to facilitate secure attachment. The fishing implement can allow for simplified preparation of fishing tackle, reduce the manual dexterity required to attach a line, and accommodate various hook sizes and line types.

In certain embodiments, a fishing implement including a fishing hook, a fishing line, and an apparatus as described herein is provided, with the apparatus disposed on the fishing hook. The fishing line can be coupled to the fishing hook via the apparatus. The apparatus can be configured to receive the fishing line between a plug and a sleeve.

In certain embodiments, a kit for coupling a fishing line to a fishing hook is provided. The kit can include one or more apparatuses as described herein, a receptacle having a body with an aperture configured to receive a portion of the fishing hook and the sleeve, and a sheath slidably coupled to the body. The sheath can move between a first position that covers at least a top portion of the fishing hook and a second position that exposes the top portion. The kit can also include one or more fishing hooks, each having an apparatus disposed on a portion of the hook, allowing for simplified preparation of multiple fishing hooks and rapid coupling of fishing lines.

In certain embodiments, a method for coupling a fishing line to a fishing hook is provided. The method can include providing a fishing line and a fishing hook, as well as an apparatus as described herein for coupling the fishing line to the fishing hook. The method can include disposing the plug on a portion of the fishing hook such that the aperture receives a portion of the hook, disposing the fishing line around a portion of the hook or the projection, and coupling the sleeve to the projection. The method can allow secure and repeatable attachment of the fishing line and can reduce the manual dexterity and strength required.

In certain embodiments, a method of using a kit for coupling a fishing line to a fishing hook is provided. The method can include providing a kit as described herein, moving the body of the receptacle from a first position to a second position in which the sheath exposes the top portion of a fishing hook, disposing a fishing line around a portion of the fishing hook or the projection, and coupling the sleeve to the projection. The method can allow secure attachment of the fishing line, can simplify the process of preparing fishing tackle, and can reduce the manual dexterity and strength required.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a top perspective view of an apparatus for coupling a fishing line to a fishing hook, according to an embodiment of the present disclosure;

FIG. 1B is a cross-sectional view of the apparatus, according to the embodiment shown in FIG. 1A;

FIG. 2 is a top perspective view of another apparatus for coupling a fishing line to a fishing hook, according to an embodiment of the present disclosure;

FIG. 3 is a front perspective view of a plug and a sleeve, according to an embodiment of the present disclosure;

FIGS. 4A-4D provide a series of top perspective views illustrating a plug and a sleeve of the apparatus coupling a fishing line therebetween, according to the embodiment shown in FIG. 1A;

FIG. 5A-C provide a series of cross-sectional views illustrating a plug and a sleeve coupling a fishing line therebetween, according to an embodiment of the present disclosure;

FIG. 6A is a front perspective view of a kit for coupling a fishing line to a fishing hook, according to an embodiment of the present disclosure;

FIG. 6B is a rear perspective view of the kit for coupling a fishing line to a fishing hook, according to the embodiment shown in FIG. 5;

FIG. 7 is a top perspective view of a body of the kit for coupling a fishing line to a fishing hook, according to the embodiment shown in FIG. 5;

FIG. 8 is a bottom perspective view of the body of the kit for coupling a fishing line to a fishing hook, according to the embodiment shown in FIG. 5;

FIG. 9 is a front elevational view of the body of the kit for coupling a fishing line to a fishing hook, according to the embodiment shown in FIG. 5;

FIG. 10 is a rear elevational view of the body of the kit for coupling a fishing line to a fishing hook, according to the embodiment shown in FIG. 5;

FIG. 11 is a top plan view of the body of the kit for coupling a fishing line to a fishing hook, according to the embodiment shown in FIG. 5;

FIG. 12 is a bottom plan view of the body of the kit for coupling a fishing line to a fishing hook, according to the embodiment shown in FIG. 5;

FIG. 13 is a bottom perspective view of a sheath of the kit for coupling a fishing line to a fishing hook, according to the embodiment shown in FIG. 5;

FIG. 14 is a top perspective view of a sheath of the kit for coupling a fishing line to a fishing hook, according to the embodiment shown in FIG. 5;

FIGS. 15A-15E provide a series of front elevational views illustrating a plug and a sleeve of the apparatus coupling a fishing line therebetween, according to the embodiments shown in FIGS. 1A and 5;

FIG. 16 is a top perspective view of a fishing implement, according to an embodiment of the present disclosure;

FIG. 17 is a flow chart illustrating a method for coupling a fishing line to a fishing hook, according to an embodiment of the present disclosure; and

FIG. 18 is a flow chart illustrating a method of using a kit for coupling a fishing line to a fishing hook, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides an apparatus for coupling a fishing line to a fishing hook. The apparatus can reduce the dexterity and strength required to couple the fishing line to the fishing hook and can accommodate a variety of fishing hook sizes and fishing line types. The apparatus can simplify the process of preparing fishing tackle under varying environmental conditions, including low-light, wet, or unstable settings, making it easier for anglers of all ages and experience levels to use. By streamlining fishing line attachment and providing a consistent, secure connection, the apparatus can reduce frustration, save time, and improve efficiency during fishing tackle preparation. In addition, the apparatus can offer repeatable and reliable performance, allowing users to quickly prepare multiple fishing hooks without compromising fishing line strength or fishing hook attachment. The design of the apparatus can support versatility, working with different fishing lines and fishing hook sizes, while minimizing the risk of line slippage, improve and secure handling of fishing hooks, and optimize time in replacing or switching out fishing tackle. The apparatus can provide a practical, user-friendly solution that addresses the challenges of line-to-hook preparation, such as manually tying knots, thereby improving the overall fishing experience for both novice and experienced anglers.

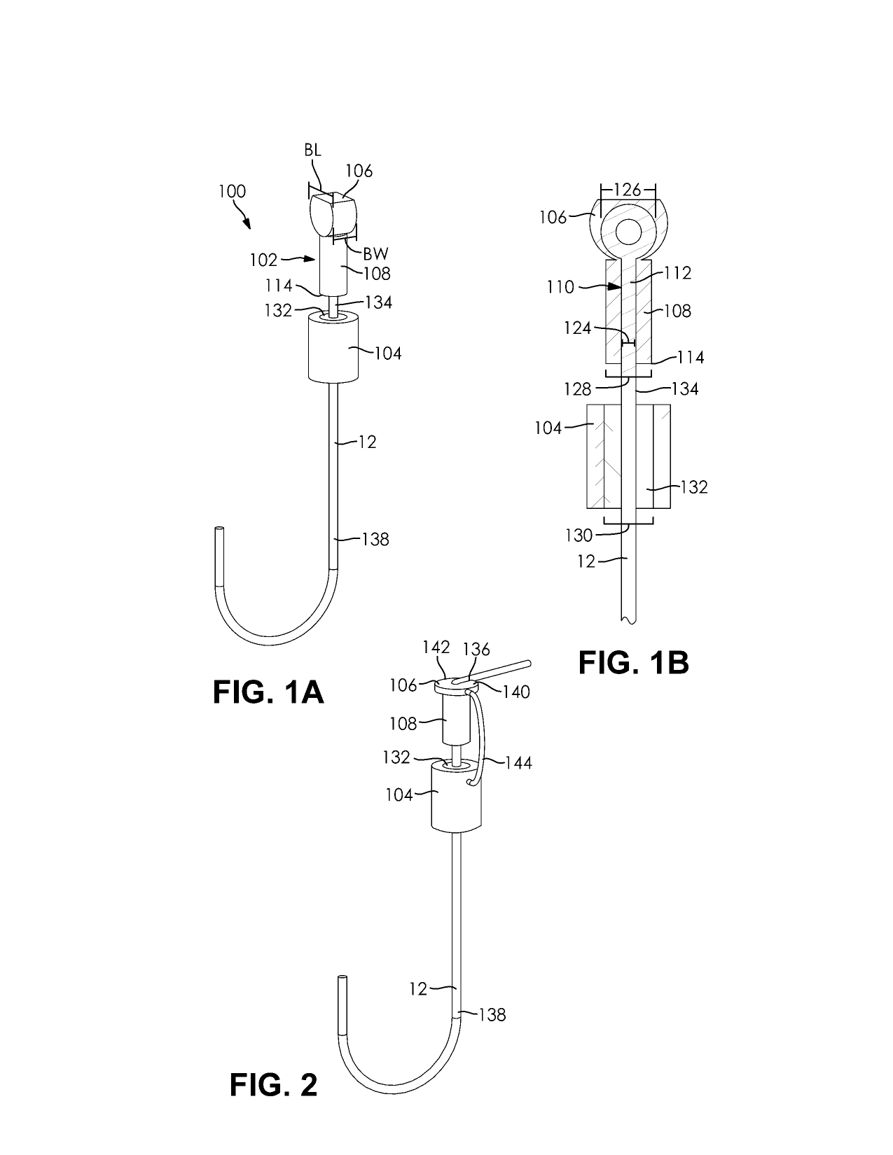

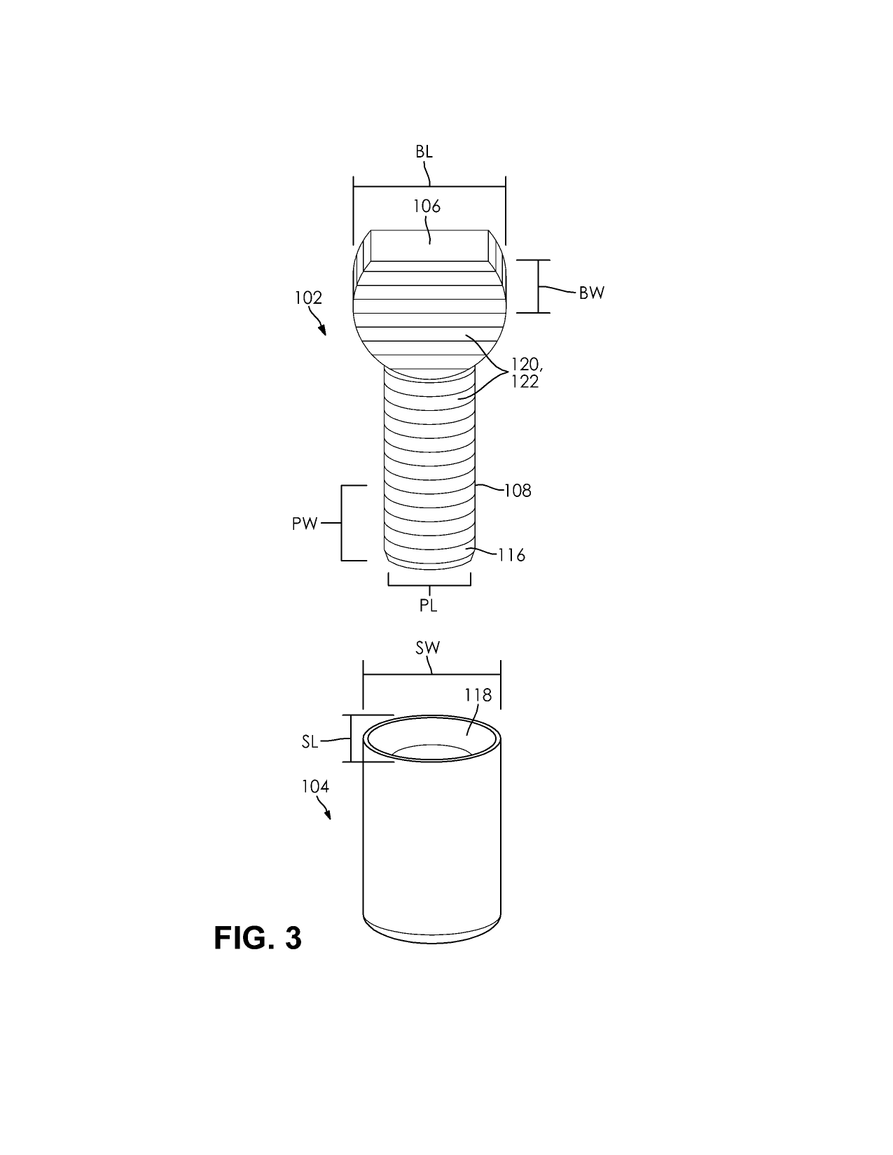

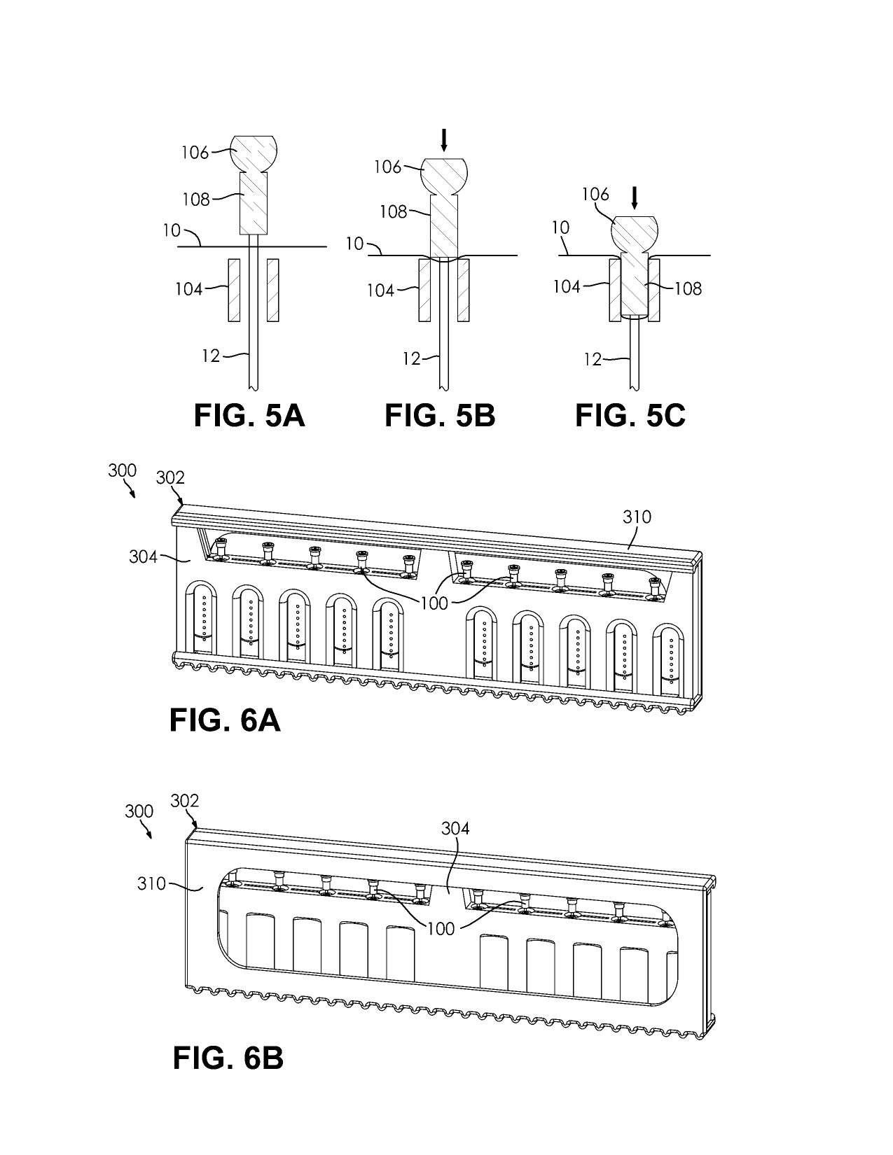

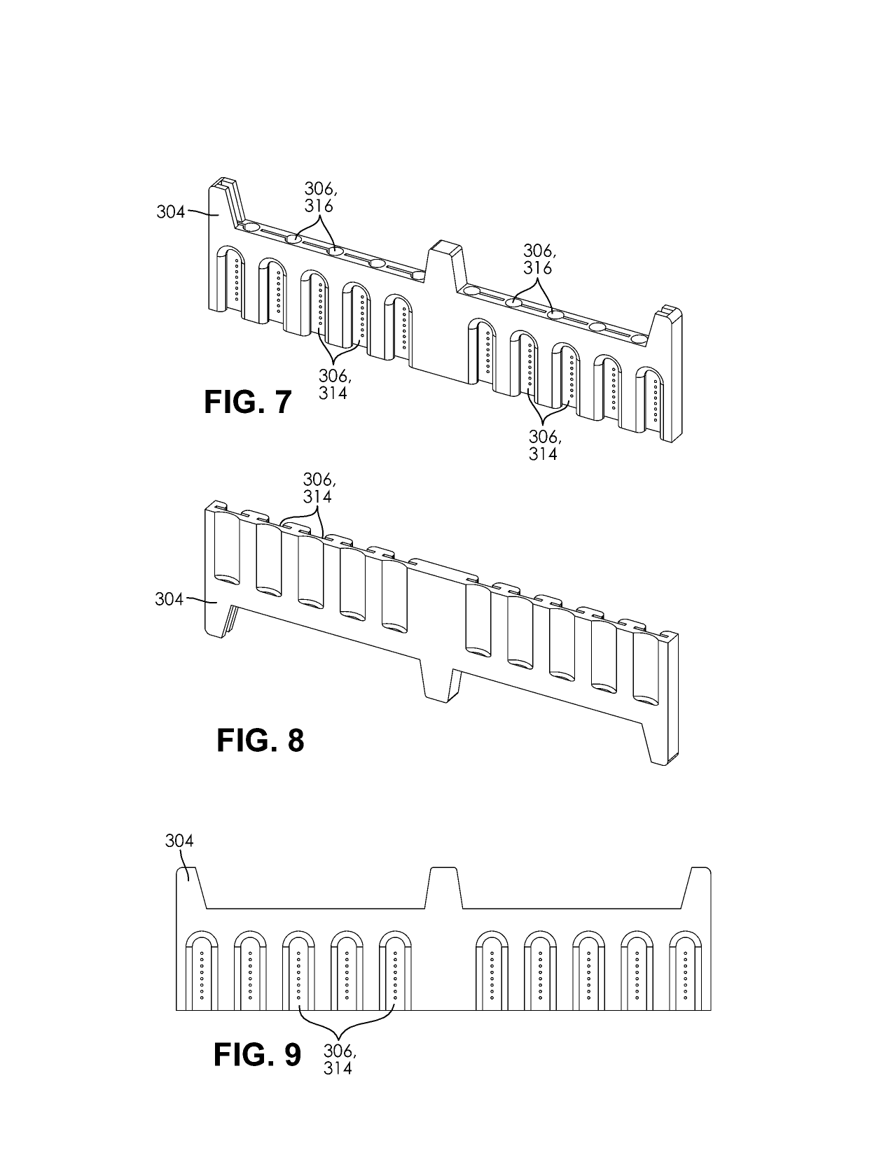

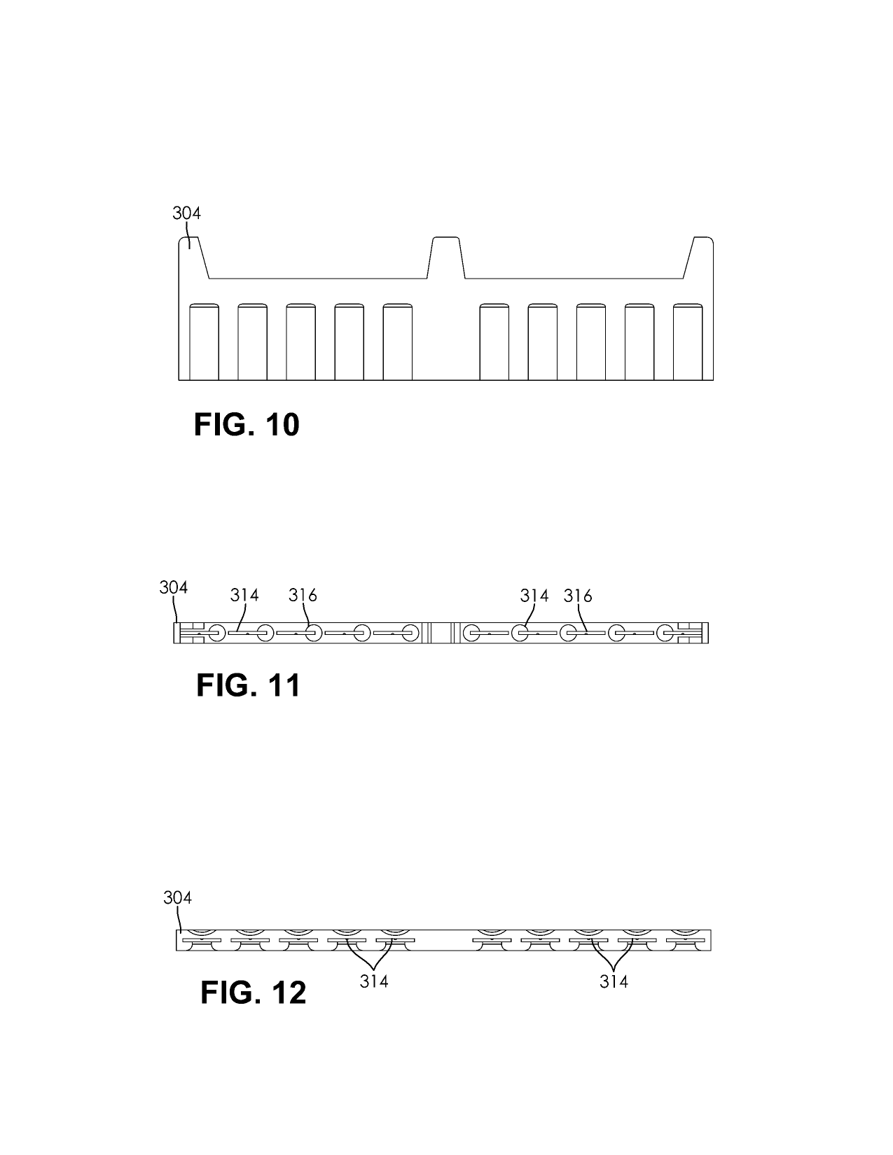

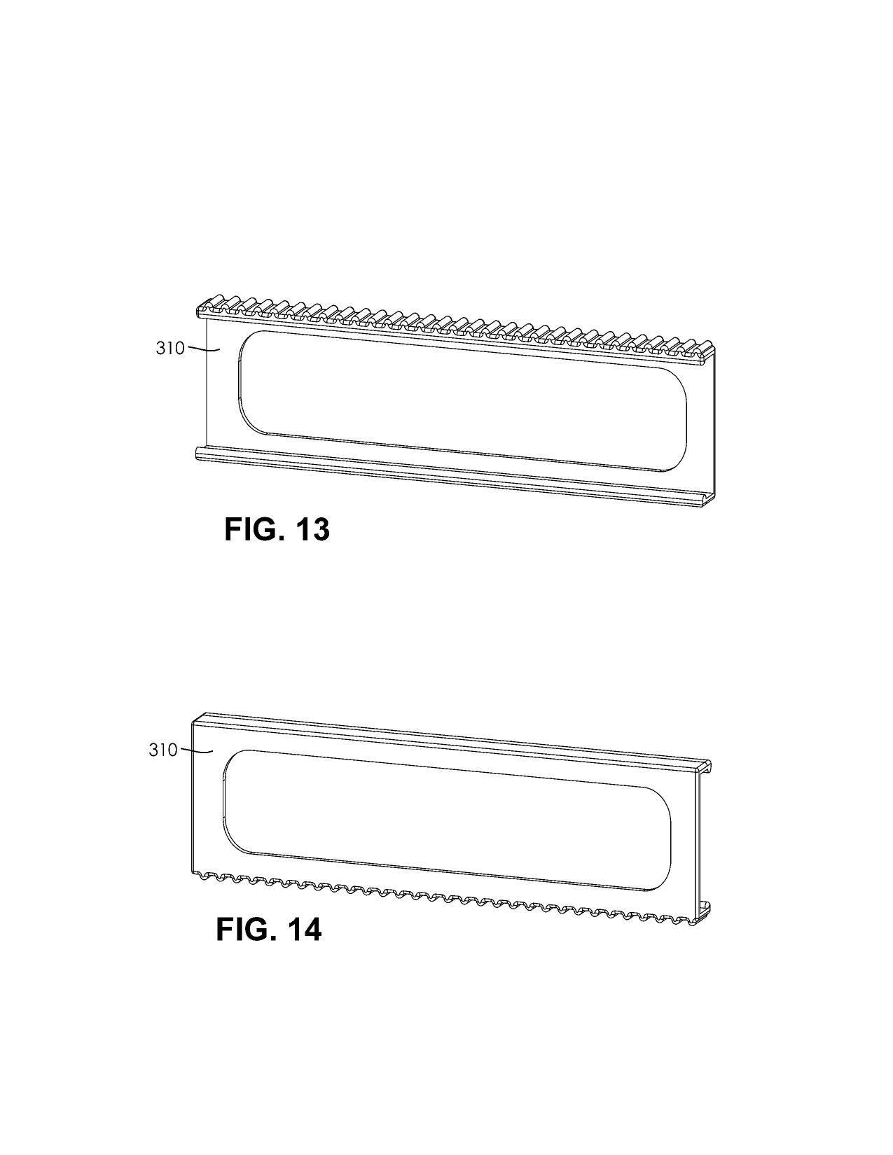

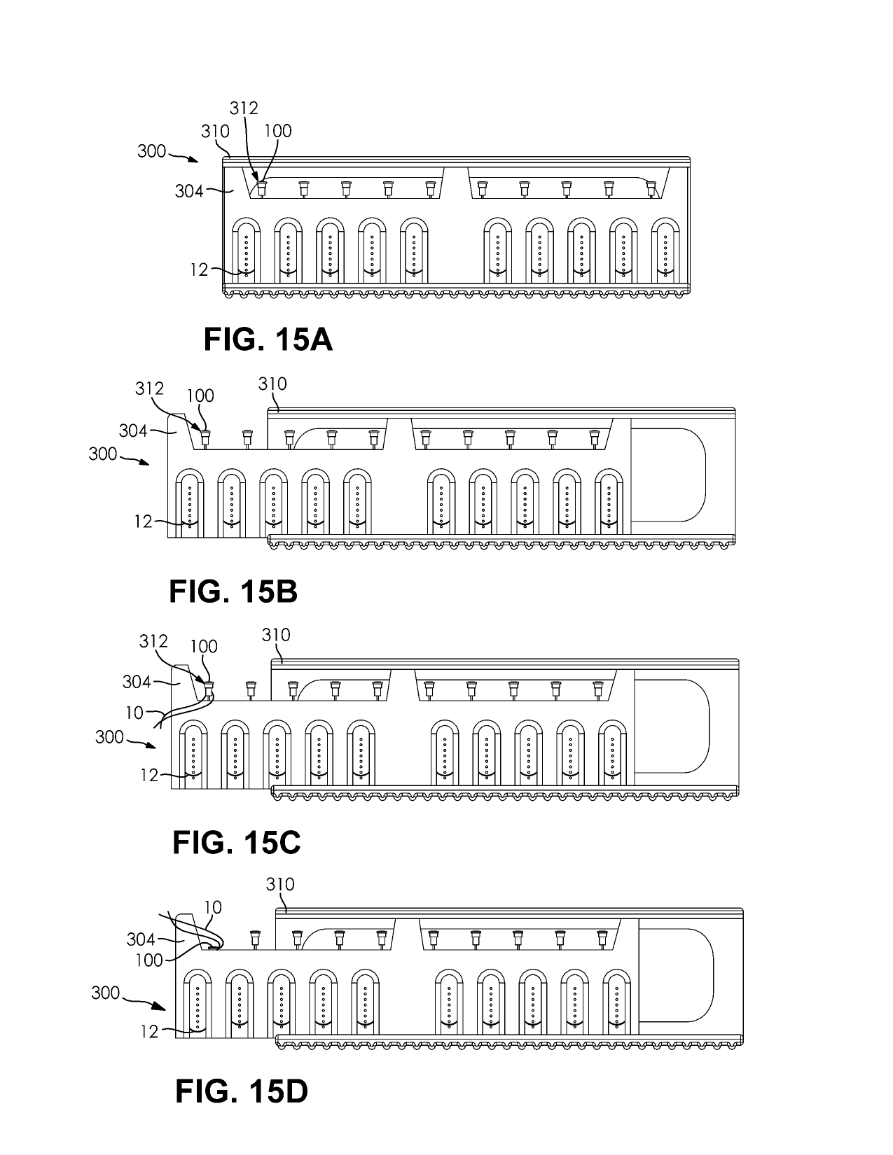

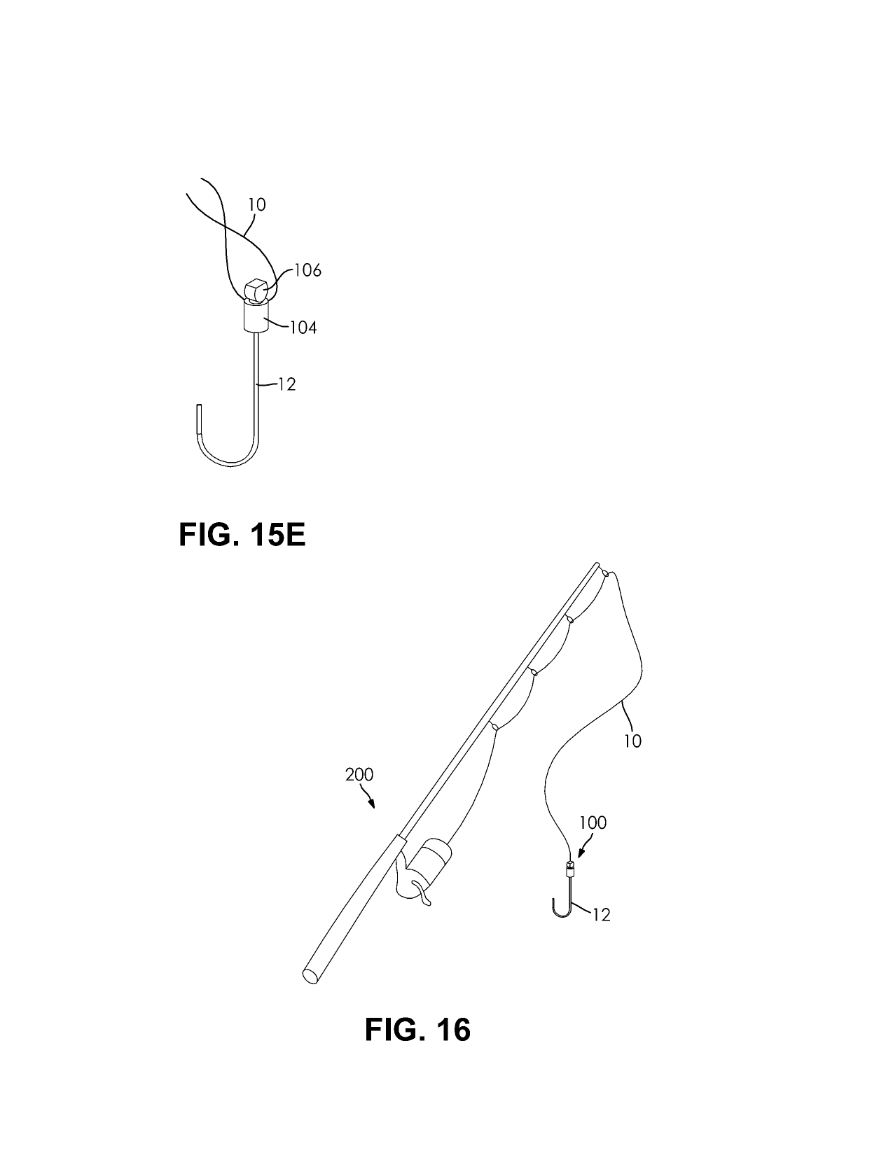

Referring now to the drawings and with reference to FIGS. 1-18, an apparatus 100 for coupling a fishing line 10 to a fishing hook 12 and ways of using the apparatus 100 are provided. The apparatus 100 can include a plug 102 and a sleeve 104. The plug 102 can include a base 106 and a projection 108 extending from the base 106. The projection 108 can have a smaller cross-sectional dimension than the base 106. It should be understood that the dimension can be a width as well as a diameter.

The base 106 can include a cross-section having a base length BL and a base width BW, and the projection 108 can include a cross-section having a projection length PL and a projection width PW. The base length BL can be greater than the projection length PL. The base width BW can be greater than the projection width PW.

The relative sizing between the base 106 and the projection 108 can militate the plug 102 from passing entirely through the sleeve 104 during coupling. Because the base length BL can be greater than the projection length PL and the base width BW can be greater than the projection width PW, the base 106 can define a shoulder that limits the insertion depth of the projection 108 into the sleeve 104. In certain embodiments, the base length BL or the base width BW can also be greater than a sleeve length SL or a sleeve width SW of the sleeve 104. This dimensional relationship can further militate against the plug 102 from passing through the sleeve 104, ensuring that the base 106 provides a positive stop when the sleeve 104 is coupled to the projection 108.

An aperture 110 can be formed in the plug 102 and can be configured to receive a portion 112 of the fishing hook 12. The sleeve 104 can selectively couple to the projection 108 of the plug 102 such that the plug 102 and sleeve 104 can receive a portion of the fishing line 10 therebetween, thereby securing the fishing line 10 to the fishing hook 12 when the plug 102 and sleeve 104 are coupled.

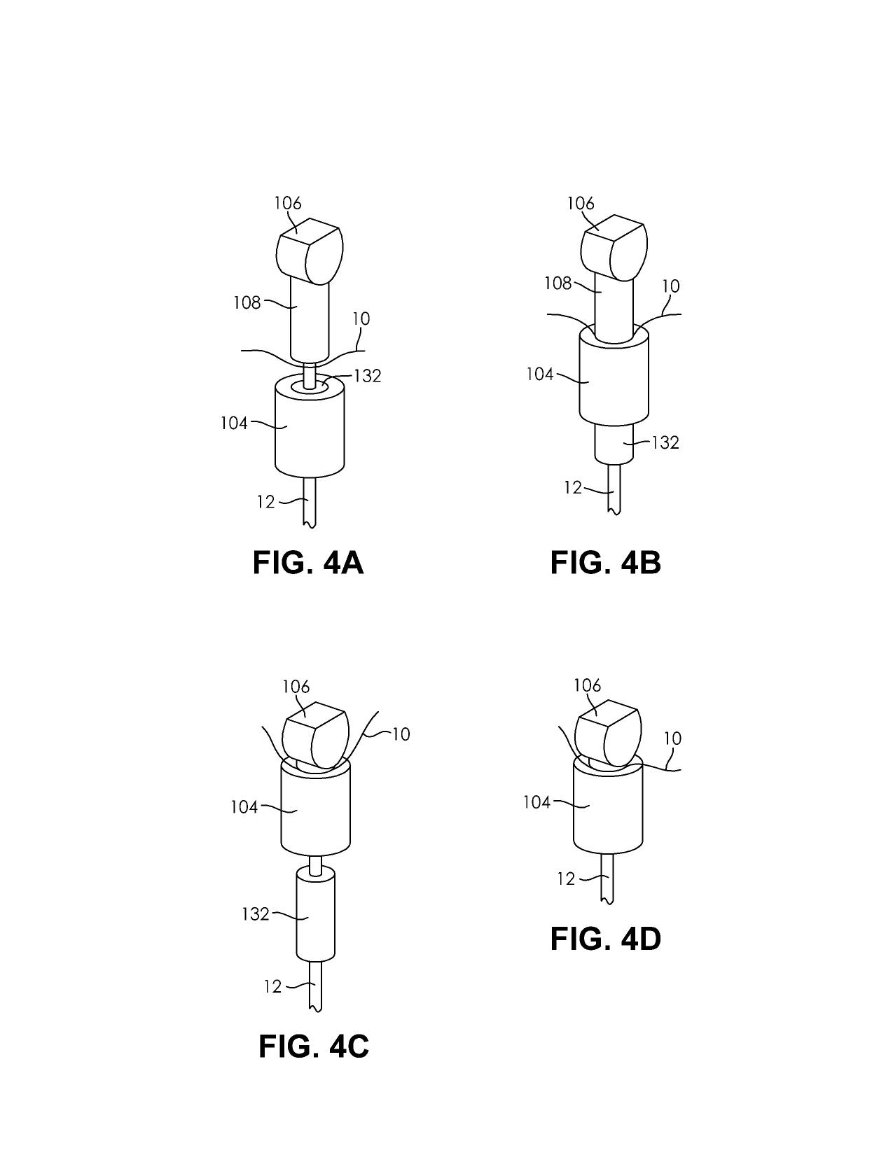

Referring to FIGS. 4A-D and 5A-C, a portion of the fishing line 10 can be positioned adjacent the distal end 114 of the projection 108 prior to insertion of the projection 108 into the sleeve 104. As the plug 102 can be advanced toward the sleeve 104, the projection 108 can engage the fishing line 10 and urge the fishing line 10 downward along an interior surface of the sleeve 104. When the projection 108 is received within the sleeve 104, the fishing line 10 can be frictionally captured between these surfaces, thereby securing the fishing line 10 without requiring knots, crimps, or other dedicated fastening components.

In certain embodiments, the apparatus 100 can further include the fishing hook 12. The fishing hook 12 can be of any type, including a J-hook, a circle hook, or a treble hook. The fishing hook 12 can be disposed within the aperture 110 of the plug 102 so that at least a portion of the fishing hook shank or eye is retained within the plug 102. It should be understood that the plug 102 can be manufactured on the portion of the fishing hook 12 such that the apparatus 100 can form a preassembled coupling system.

In certain embodiments, the apparatus 100 can further include an intermediate device. The intermediate device can include a swivel, a snap, or a leader (not shown). A portion of the swivel, the snap, or the leader can be disposed within the aperture 110 of the plug 102 so that the plug 102 can function as a connector between the fishing line 10 and the intermediate device. This arrangement can allow the apparatus 100 to be integrated into rigs or tackle assemblies that rely on swivels, snaps, or leader components. The intermediate device can militate against line twist, enable quick attachment or detachment of terminal tackle, and provide modularity in fishing setups. The inclusion of the intermediate device can allow the apparatus 100 to be used in a broader range of fishing applications and can accommodate different angling preferences or rigging techniques.

In certain embodiments, the plug 102 of the apparatus 100 can be overmolded onto a portion 112 of the fishing hook 12, the snap, the swivel, or leader component. Overmolding can allow the plug 102 to form around the fishing hook shank or eye, thereby creating a fixed and durable bond between the plug 102 and the fishing hook 12. The overmolding can be achieved using polymeric or elastomeric materials that conform to the geometry of the fishing hook 12.

In certain embodiments, the base 106 of the plug 102 can include various cross-sectional shapes. For example, the base 106 can include a shape having a cross-section that is circular, square, triangular, rectangular, oval, hexagonal, octagonal, trapezoidal, elliptical, and combinations thereof. With reference to FIGS. 1A, 2, and 4, the base can include a rectangular cross-section. The rectangular cross-section can have a dimension, such as a length of the base 106, that can contact or engage an exterior portion of the sleeve 104, thereby militating against base 106 of the plug 102 from passing completely through the sleeve 104 when the projection 108 is coupled to the sleeve 104.

In certain embodiments, and with reference to FIG. 2, the base 106 can include a channel 136 configured to receive another portion 138 of the fishing hook 12. The channel 136 can be disposed on a side 140 of the base 106 opposite the projection 108. The channel 136 can extend from the aperture 110 to an outer edge 142 of the base 106. The channel 136 can provide a continuous passage for the fishing hook 12.

In certain embodiments, the projection 108 of the plug 102 can include various cross-sectional shapes. The projection 108 can include various cross-sectional shapes, including cross-sectional shapes that are circular, square, triangular, rectangular, oval, hexagonal, octagonal, trapezoidal, elliptical, cross-shape, and combinations thereof. With reference to FIGS. 1, 2, and 4, the projection 108 of the plug 102 can include a circular cross-section. The projection 108 having a circular cross-section can facilitate radial engagement with the sleeve 104, providing distribution of compression forces. The circular cross-section can simplify alignment during assembly and can enhance the reliability of an interference fit with an interior surface of the sleeve 104.

In certain embodiments, the projection 108 can extend along a longitudinal axis of the plug 102. A distal end 114 of the projection 108 can include a bevel 116 to facilitate coupling of the sleeve 104 to the projection 108. The bevel 116 can serve as a lead-in to guide the sleeve 104 during coupling. The bevel 116 can also facilitate achieving a smooth engagement that minimizes wear on the interior surface of the sleeve 104. The projection 108 can be tapered such that the projection 108 gradually narrows toward the distal end 114.

In certain embodiments, the sleeve 104 can include a bevel 118 to facilitate coupling of the sleeve 104 to the projection 108. The bevel 118 can serve as a lead-in to guide the projection 108 during coupling. The bevel 118 can also facilitate achieving a smooth engagement that minimizes wear on the interior surface of the sleeve 104.

In certain embodiments, the plug 102 and the projection 108 can include a textured surface 120. The textured surface 120 can increase frictional engagement between the projection 108 and the sleeve 104, thereby improving retention when the projection 108 and the sleeve 104 are coupled. The textured surface 120 can be formed through molding, machining, or surface treatment processes. The textured surface 120 can include a plurality of grooves 122 disposed circumferentially about a longitudinal axis of the plug 102 and the projection 108. The plurality of grooves 122 can form a series of ridges that interact with the inner wall of the sleeve 104, and the entrapped fishing line, to improve mechanical retention. The plurality of grooves 122 can resist axial movement of the sleeve 104 (it also will resist slippage of the fishing line. The grooves will grip onto the fishing line) once coupled with the projection 108. The plurality of grooves 122 can also channel water or debris away, maintaining reliable engagement.

In certain embodiments, the aperture 110 of the plug 102 can include a circular cross-section. The aperture 110 can be dimensioned to correspond to the diameter of the fishing hook 12. The aperture 110 can be disposed along the longitudinal axis of the plug 102. The aperture 110 can extend from a distal end 114 of the projection 108 toward the base 106 and can terminate within the base 106. This partial-through configuration can militate against the fishing hook 12 from exiting the opposite side of the plug 102.

In certain embodiments, the aperture 110 can include a first diameter 124 adjacent the distal end 114 of the projection 108 and a second diameter 126 adjacent the base 106. The difference in diameters can create a stepped or a tapered configuration. The second diameter 126 can be larger than the first diameter 124 to accommodate the eye of the fishing hook 12.

In certain embodiments, the aperture 110 can extend through both the base 106 and the projection 108. This through-aperture configuration can permit the fishing hook 12 to pass completely through the plug 102.

In certain embodiments, the sleeve 104 can include various cross-sectional shapes. For example, the sleeve can include a cross-sectional shape that is circular, oval, rectangular, polygonal, loop-shaped, and combinations thereof. The cross-sectional shape of the sleeve 104 can correspond to a shape of a portion of the projection 108 to ensure a complementary fit. The sleeve 104 can also include exterior designs that enhance both functionality and aesthetic appeal. For instance, the sleeve 104 can be formed to resemble any number of fishing lures, such as a worm, a kernel of corn, a salmon egg, a marshmallow, or a fly. Incorporating fishing lure designs into the sleeve 104 can provide several advantages. By resembling natural or artificial bait commonly used in fishing, the sleeve 104 can more readily help attract fish. This configuration can eliminate the need for additional bait in certain scenarios, thereby simplifying fishing and reducing preparation time.

It should be understood that the projection 108 and the sleeve 104 can be configured to form an interference fit when coupled. The interference fit can create a frictional retention force that secures the sleeve 104 and plug 102 together. Such a coupling mechanism can eliminate the need for adhesives or mechanical fasteners. The interference fit can be defined by a difference in an outer dimension of the projection 108 and an inner dimension of the sleeve 104. This dimensional difference can generate compression when the sleeve 104 is installed over the projection 108. The resulting engagement can couple the fishing line 10 and can militate against unintentional separation during use. The tolerance range can be optimized for different materials or environmental conditions. Insertion of the projection 108 into the sleeve 104 can be accomplished using a finger or thumb of a user, or by employing a lever or fulcrum mechanism that can provide mechanical advantage.

In certain embodiments, the interference fit can be defined by a difference between an outer diameter 128 of a portion of the projection 108 and an inner diameter 130 of a portion of the sleeve 104. The outer diameter 128 of the portion of the projection 108 can be larger than the inner diameter 130 of the portion of the sleeve 104. This dimensional relationship can ensure elastic deformation of the projection 108 and sleeve 104 during coupling. The difference in the outer diameter 128 and the inner diameter 130 can provide retention forces. The configuration can enable repeatable assembly while maintaining sufficient resistance to decoupling. It should be understood that the degree of interference can be selected to balance ease of use, slippage of the fishing line 10, and coupling strength.

In certain embodiments, the interference fit can be defined by an effective diameter of the projection 108. The effective diameter can be provided by the inclusion of the fishing line 10 disposed between the projection 108 and the sleeve 104. The outer diameter 128 of the projection 108 can be equal to, or slightly smaller than, the inner diameter 130 of the sleeve 104. When the fishing line 10 is positioned on or around the projection 108 and the sleeve 104 is advanced over it, the combined thickness can generate the dimensional interference needed to couple the fishing line 10, sleeve 104, and projection 108 together. This configuration can enable an interference fit even without the projection 108 directly exceeding the inner diameter 130 of the sleeve 104, thereby accommodating a range of fishing line diameters while still providing reliable retention forces.

In certain embodiments, the sleeve 104 can include an insert 132 configured to secure the sleeve 104 to the fishing hook 12. The insert 132 can be positioned within the sleeve 104. The insert 132 can be formed from a deformable or adhesive-compatible material. The inclusion of the insert 132 can enable temporary or dissolvable coupling options. The insert 132 can be coupled to the sleeve 104 by an adhesive, which can provide a semi-permanent attachment, or by an interference fit between an outer surface of the insert 132 and an inner surface of the sleeve 104. Either configuration can allow the insert 132 and the sleeve 104 to remain in place relative to the fishing hook 12 during use while still permitting easy assembly and replacement when desired. In selectively coupling the sleeve 104 to the plug 102, all or a portion of the insert 132 can be pushed out of the sleeve 104 by the projection 108 of the plug 102.

In certain embodiments, the insert 132 can include a material configured to at least partially dissolve in water. The dissolvable nature of the material can allow for timed release or automatic detachment from the fishing hook 12. The dissolution rate can be controlled by material composition or thickness. The material can include polyvinyl alcohol. Polyvinyl alcohol can provide predictable water solubility and sufficient initial strength. The material can be molded or cast into the insert shape.

In certain embodiments, the apparatus 100 can include a living hinge 144 configured to couple the plug 102 and the sleeve 104. The living hinge 144 can provide a flexible connection that allows the sleeve 104 to move relative to the plug 102 during assembly. The living hinge 144 can simplify alignment and reduce the risk of component loss while maintaining functionality.

In certain embodiments, and with reference to FIG. 16, a fishing implement 200 is provided. The fishing implement 200 can include a fishing line 10, a fishing hook 12, and the apparatus 100 for coupling the fishing line 10 to the fishing hook 12 as described herein. The apparatus 100 can be disposed on the fishing hook 12 to facilitate coupling of the fishing line 10 without requiring the user to tie knots or use specialized tools. The fishing hook 12 can be of any type, size, or material used in fishing, including metal or composite fishing hooks, and can include an eye, shank, bend, and barb. When assembled, the apparatus 100 can securely couple the fishing line 10 in engagement with the fishing hook 12, providing a reliable and repeatable attachment suitable for a variety of fishing conditions.

In certain embodiments, the fishing implement 200 can include a fishing line 10 coupled to the fishing hook via the apparatus 100. The fishing line can be received between the sleeve 104 and projection 108 of the apparatus 100 or another portion 134 of the fishing hook 12, such that the fishing line 10 can be retained therebetween when the sleeve 104 and plug 102 are coupled. The fishing line 10 can include monofilament, braided, or fluorocarbon materials, and can vary in diameter depending on the type of fishing application. When assembled, the fishing implement 200 can provide a secure, efficient, and user-friendly method for coupling the fishing line 10 to the fishing hook 12.

In certain embodiments, a kit 300 for coupling a fishing line 10 to a fishing hook 12 is provided. The apparatus 100 can be the apparatus as described herein. The kit 300 can include a receptacle 302 having a body 304 including an aperture 306 configured to receive another portion 134 of the fishing hook 12 and the sleeve 104. A sheath 310 can be slidably coupled to the body 304 and configured to move between a first position in which the sheath 310 covers at least a top portion 312 of the fishing hook 12 and a second position in which the sheath 310 exposes the top portion 312 of the fishing hook 12. The kit 300 can further include the fishing hook 12 disposed in the aperture 306 of the body 304 of the receptacle 302, with the sleeve 104 disposed around another portion 134 of the fishing hook 12 and the plug 102 disposed on the portion 112 of the fishing hook 12.

In certain embodiments, the aperture 306 of the body 304 can include a first portion 314 configured to receive the portion 138 of the fishing hook 12 and a second portion 316 configured to receive the sleeve 104. The first portion 314 can have a smaller diameter than the second portion 316 to conform to the differing geometries of the fishing hook 12 and sleeve 104. This arrangement can facilitate the placement of the fishing hook 12 and sleeve 104 within the body 304 of the receptacle 302.

In certain embodiments, the receptacle 302 can include a plurality of apertures 306. Each aperture 306 can be configured to receive an individual fishing hook 12, enabling the kit 300 to simultaneously store multiple fishing hooks 12. The plurality of apertures 306 can be disposed linearly along a longitudinal axis of the body 304.

In certain embodiments, the sheath can be configured to slide along the longitudinal axis of the body 304. The sliding motion can allow the sheath 310 to move between positions that selectively cover or expose the fishing hook 12, providing protection during transport and accessibility during preparation. The sheath 310 can include a polymeric, an elastomeric, a metallic, a wood, or a composite material that can facilitate smooth motion relative to the body 304. The sheath 310 can further include textured or contoured surfaces to improve user grip and control during use.

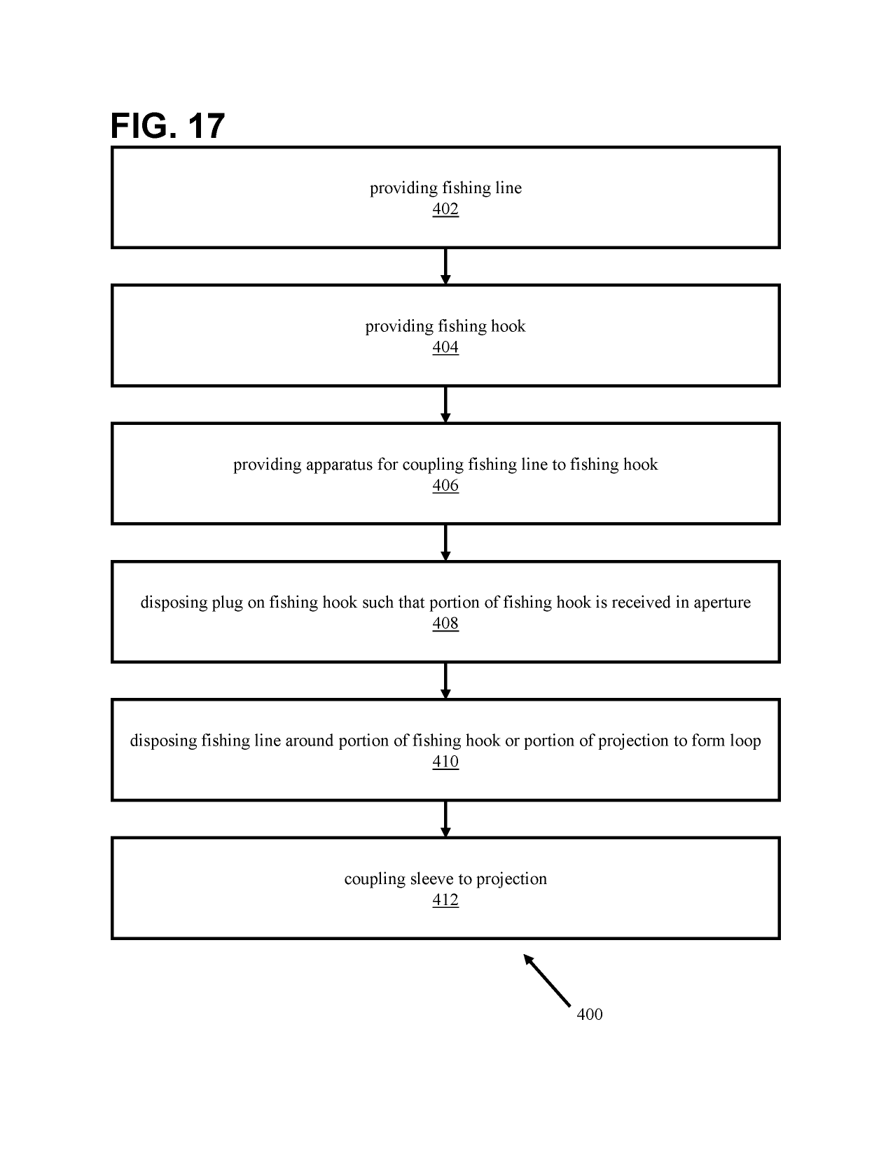

In certain embodiments, and with reference to FIG. 17, a method 400 for coupling a fishing line 10 to a fishing hook 12 is provided. The method 400 can include providing the fishing line 10. The fishing line 10 can be of any suitable material or diameter and can include monofilament, fluorocarbon, braided, or hybrid compositions. The fishing line 10 can be adapted for use with a variety of fishing hooks and environmental conditions, allowing for consistent performance when subjected to water exposure, tension, or environmental variations.

The method 400 can also include providing the fishing hook 12. The fishing hook 12 can include a shank, a bend, and a point, and can further include an eye or other attachment feature. The fishing hook can be of any size, shape, or gauge suitable for the target species or fishing conditions. The fishing hook can be formed of materials such as steel, carbon steel, or corrosion-resistant alloys, and can be configured for compatibility with the apparatus described herein. The method 400 can include providing an apparatus for coupling the fishing line to the fishing hook as described herein.

The method 400 can include disposing the plug 102 on the fishing hook 12 such that a portion of the fishing hook 12 is received in the aperture 110. The plug 102 can be positioned so that the aperture 110 aligns with the portion of the fishing hook 12 adjacent to its eye, shank, or bend depending on the configuration. The method 400 can include disposing a portion of the fishing line 10 around a portion of the fishing hook 12 or a portion of the projection 108. The portion of the fishing line 10 can be positioned to ensure that the fishing line 10 can be received at the interface between the plug 102 and the sleeve 104 when the plug 102 and the sleeve 104 are coupled. The method 400 can include coupling the sleeve 104 to the projection 108. The sleeve 104 can be moved into engagement with the projection 108 such that the sleeve 104 and the projection 108 define an interference or frictional fit. When coupled, the plug 102 and sleeve 104 can retain the portion of the fishing line 10 therebetween, thereby securing the fishing line 10 to the fishing hook 12. This configuration can permit reliable attachment without the need for knot-tying or additional tools, enabling simplified assembly under a variety of fishing or environmental conditions.

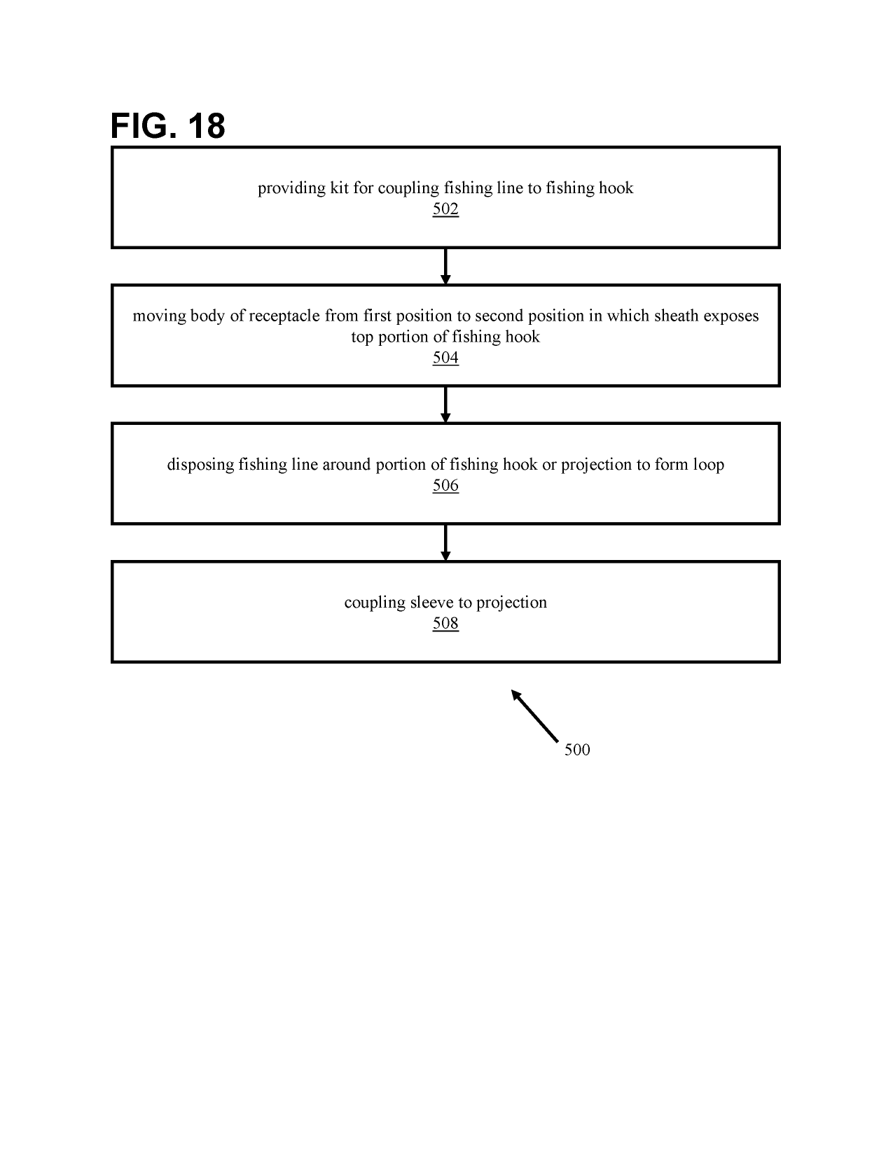

In certain embodiments, and with reference to FIG. 18, a method 500 of using a kit 300 for coupling a fishing line 10 to a fishing hook 12 is provided. The method 500 can include providing the kit 300 as described herein. The method 500 can include moving the body 304 of the receptacle 302 from the first position to the second position in which the sheath 310 exposes the top portion 312 of the fishing hook 12. The sheath 310 can be slidably coupled to the body 304 such that it can travel along a longitudinal axis of the body 304. When in the first position, the sheath 310 can cover at least the top portion 312 of the fishing hook 12 to militate against unintentional contact or snagging. When the sheath 310 is moved to the second position, the top portion 312 of the fishing hook 12 can be exposed, permitting the user to engage with the fishing hook 12 for subsequent coupling.

The method 500 can also include disposing a portion of the fishing line 10 around a portion of the fishing hook 12 or the projection 108. The portion of the fishing line 10 can be positioned such that the fishing line 10 can be received between the plug 102 and the sleeve 104 when the plug 102 and the sleeve 104 are coupled.

The method 500 can include coupling the sleeve 104 to the projection 108. The sleeve 104 can be pressed or otherwise advanced along the projection 108 until the sleeve 104 and plug 102 form a frictional or interference fit, thereby coupling the fishing line 10 to the fishing hook 12. The coupling action can secure the portion of the fishing line 10 between the sleeve 104 and the plug 102 without requiring knot-tying or specialized tools. The resulting assembly can provide a reliable, repeatable, and user-friendly connection between the fishing line 10 and the fishing hook 12 suitable for various environmental conditions. It should be understood that coupling the sleeve 104 to the projection 108 can include pressing the plug into the sleeve 104 until the sleeve 104 and the plug 102 form the interference fit. The interference fit can be defined by a difference between an outer diameter of the projection 108 and an inner diameter of the sleeve 104, allowing the sleeve 104 and the projection 108 to retain the fishing line 10 by compression.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An apparatus for coupling a fishing line to a fishing hook, comprising:
a plug including:
a base;
a projection extending from the base, the projection having a smaller cross-sectional dimension than the base; and
an aperture formed in the plug, the aperture configured to receive a portion of the fishing hook; and
a sleeve configured to selectively couple to the projection of the plug, the plug and the sleeve configured to receive a portion of the fishing line therebetween, thereby securing the portion of the fishing line to the fishing hook when the sleeve is coupled to the projection.

2. The apparatus of claim 1, further comprising a fishing hook.

3. The apparatus of claim 1, wherein the base includes a rectangular cross-section and the projection includes a circular cross-section, a width of the rectangular cross-section being greater than a diameter of the circular cross-section.

4. The apparatus of claim 1, wherein:
the base includes a cross-section having a base length and a base width;
the projection includes a cross-section having a projection length and a projection width; and
the base length is greater than the projection length or the base width is greater than the projection width.

5. The apparatus of claim 1, wherein the projection extends along a longitudinal axis of the plug.

6. The apparatus of claim 1, wherein a distal end of the projection includes a bevel configured to facilitate coupling of the sleeve to the projection.

7. The apparatus of claim 1, wherein the aperture includes a circular cross-section.

8. The apparatus of claim 7, wherein the aperture is formed along a longitudinal axis of the plug.

9. The apparatus of claim 8, wherein the aperture extends from a distal end of the projection toward the base and terminates within the base.

10. The apparatus of claim 9, wherein the aperture includes a first diameter adjacent the distal end of the projection and a second diameter adjacent the base.

11. The apparatus of claim 1, wherein the projection and the sleeve are configured to form an interference fit when the sleeve is coupled to the projection.

12. The apparatus of claim 11, wherein the interference fit is defined by a difference between an outer diameter of a portion of the projection and an inner diameter of a portion of the sleeve.

13. The apparatus of claim 12, wherein the outer diameter of the portion of the projection is larger than the inner diameter of the portion of the sleeve.

14. An apparatus for coupling a fishing line to a fishing hook, comprising:
the apparatus of claim 1;
wherein:
the base includes a rectangular cross-section,
the projection includes a circular cross-section,
a distal end of the projection includes a beveled surface configured to facilitate coupling of the sleeve to the projection,
the aperture is disposed along a longitudinal axis of the plug,
the aperture extends from a distal end of the projection toward the base and terminates within the base,
the aperture includes a flared portion adjacent the base configured to accommodate an eye of the fishing hook,
the sleeve includes a circular cross-section,
the projection and the sleeve are configured to form an interference fit when the sleeve is coupled to the projection,
the interference fit is defined by a difference between an outer diameter of a portion of the projection and an inner diameter of a portion of the sleeve,
the outer diameter of the portion of the projection is larger than the inner diameter of the portion of the sleeve,
the sleeve includes an insert configured to secure the sleeve to the fishing hook,
the insert comprises a material configured to at least partially dissolve in water, and
the material comprises polyvinyl alcohol.

15. A fishing implement, comprising:
a fishing hook; and
the apparatus of claim 1, wherein the portion of the fishing hook is received by the aperture.

16. The fishing implement of claim 15, wherein the plug is overmolded onto another portion of the fishing hook.

17. A fishing implement, comprising:
a fishing hook;
a fishing line; and
the apparatus of claim 1, wherein the portion of the fishing hook is received by the aperture, the portion of the fishing line is received between the plug and the sleeve, and the sleeve is selectively coupled to the projection of the plug.

18. A method for coupling a fishing line to a fishing hook, comprising:
providing the fishing line;
providing the fishing hook;
providing an apparatus for coupling the fishing line to the fishing hook, the apparatus comprising:
a plug including:
a base;
a projection extending from the base, the projection having a smaller cross-sectional dimension than the base; and
an aperture configured to receive a portion of the fishing hook; and
a sleeve configured to selectively couple to the projection;
the plug and the sleeve are configured to receive a portion of the fishing line therebetween, thereby securing the portion of the fishing line to the fishing hook when the sleeve is coupled to the projection; and
coupling the sleeve to the projection.

19. A kit for coupling a fishing line to a fishing hook, comprising:
an apparatus comprising:
a plug including:
a base;
a projection extending from the base, the projection having a smaller cross-sectional dimension than the base; and
an aperture configured to receive a portion of the fishing hook; and
a sleeve configured to selectively couple to the projection;
the plug and the sleeve are configured to receive a portion of the fishing line therebetween, thereby securing the portion of the fishing line to the fishing hook when the sleeve is coupled to the projection;
a receptacle comprising:
a body including an aperture configured to receive another portion of the fishing hook and the sleeve;
a sheath slidably coupled to the body and configured to move between a first position in which the sheath covers at least a top portion of the fishing hook and a second position in which the sheath exposes the top portion of the fishing hook;
a fishing hook disposed in the aperture of the body;
the sleeve disposed around another portion of the fishing hook; and
the plug disposed on the portion of the fishing hook.

20. A method of using a kit for coupling a fishing line to a fishing hook, the method comprising:
providing the kit of claim 19;
moving the body of the receptacle from the first position to the second position in which the sheath exposes the top portion of the fishing hook;
disposing the fishing line around a portion of the fishing hook or the projection to form a loop; and
coupling the sleeve to the projection.
